(19) United States
(12) Patent Application Publication
(10) Pub. No.: US 2013/0296748 A1
(43) Pub. Date: Nov. 7, 2013

(54) METHOD OF MASSAGE FOR IMPROVING OF BODY CONDITION, DIAGNOSIS, PREVENTION AND TREATMENT DISEASES, AND THE MASSAGE DEVICE FOR THESE PURPOSES.

(71) Applicants: Sitkovetskiy Lev N., New London, CT (US); Sitkovetskiy Dmitriy L., East Lyme, CT (US); Daniel D. Sitkovetskiy, East Lyme, CT (US)

(72) Inventors: Sitkovetskiy Lev N., New London, CT (US); Sitkovetskiy Dmitriy L., East Lyme, CT (US); Daniel D. Sitkovetskiy, East Lyme, CT (US)

(73) Assignee: Lev N. Sitkovetskiy, New London, CT (US)

(21) Appl. No.: 13/463,744

(22) Filed: May 3, 2012

(51) Int. Cl. A61H 7/00

(52) U.S. Cl. 601/85; 601/112; 601/97

(57) ABSTRACT

The method of massage for improving the body condition as well as diagnosis, prevention and treatment of diseases consist of creating the friction between the skin's surface of the patient and the end of influencing head of the massage device with the forward and backward reversible angular turning motion, and stopping or repeating the linear or spiral movements of the massage device along the patient skin's surface with named motion of the end of influencing head and the pressure applied to the treatment skin's surfaces.

The massage device design consists of the forward and backward reversible angular turning motion mechanism such as the reversible electric engine with the angular turning motion reverse system while this mechanism contains a moving part that contains the influencing head with the end in the form of the friction surface such as a flat form.

### FIELD OF THE INVENTION

The present invention generally relates to the massage methods and electric massage devices for applying the friction with pressure to the body surface with the object of improvement of body condition as well as diagnosis, prevention and treatment diseases.

### BACKGROUND OF THE INVENTION

Many existent methods of massage and massage devices have been proposed or made to generally supply the friction with pressure massage to patients. However, none of them are specifically directed to the needed method and massage device with complex opportunity for improvement of body condition as well as diagnosis, prevention and treatment diseases.

Methods of diagnosis related to massage are the palpation and methods that used the instruments for substitution palpation. The most pertinent prior arts known to the inventions are U.S. Pat. No. 6,887,211 for through soft tissue mobilization therapies. Some massage instruments have also additional properties for increasing their influence. U.S. Pat. No. 5,843,005 contains a negative ion emitting surface covering at least a portion of the tool part or the handle part, and the negative ion emitting surfaces consist of ebonite.

All known methods of the instrument's massage have limited possibilities and do not reach the efficiency of the diagnosis with palpation and the manual massage of the classical system. Accordingly, the instrument massage devices have limited using in the diagnosis, treatment and improvement of body condition.

The methods of massage therapy consist of creating the friction between the skin of patient and the influencing part of a massage device with pressure. There are many types of the massage methods and electric massage devices related the type of moving the influencing part of massage device and design of this one. The most pertinent prior arts known to the inventions are: U.S. Pat. No. 6,517,499 contains the rollers with reciprocating linear motion, U.S. Pat. No. 6,251,089 contains massage heads to obtain selected stroking, rubbing and/or kneading massaging effects by an active or passive reciprocal arc movement for body and joints massage, U.S. Pat. No. 5,085,207 contains the finger, which is powered in a back and forth transverse motion, and CN Pat. 201658505 wherein the middle pin shaft is driven to realize back-and-forth swinging, thus leading the massage head to simulate a massage method and a kneading method of the traditional Chinese medicine massage.

All known methods of the massage and electric massage devices are enough efficient for the influence upon soft tissue and muscular processes and diseases connected with these processes, but insufficient for increasing the energy metabolism of the organism, strengthening the muscles and capillary blood circulation, improving appearance of persons skin, and reduction of the inflammation processes. They do not have high level of the influence upon skin and subcutaneous processes as well as the influences upon tissue swelling and bone outgrowth, and, moreover, do not have the possibility of diagnosis and prevention diseases.

The novel method of massage and the massage device is intended for eliminating this deficiency. Proposed novel method of the massage and the massage device solves the specified above problems, and vastly exceeds the efficiency of the known massage devices and the manual massage methods. This result was reached by the principal new massage method of influence on the skin and internal tissue.

### SUMMARY OF THE INVENTION

The present invention was designed with the object of creation scientifically motivated massage method for improvement of the body condition as well as diagnosis, prevention and treatments the numerous diseases by using the novelty physical method of massage the body surfaces and development the possible massage devices corresponding to these purposes.

The most essential differences of the novel invention are that the method of improvement of the body condition as well as diagnosis, prevention and treatment diseases consists of creating the friction between skin's surface of patient and the end of influencing head of the massage device with forward and backward reversible angular turning motion of the influencing head applied with the constant or variable pressure to the skin's surface either manually or mechanically. This type of friction between the skin of patient and the friction end of influencing head of the massage device creates the forward and backward reversible angular turning movement of the skin. In the result of this movement of the skin the pumping effect of increasing the blood circulation is produced. The maximum length of this skin movement cannot be more than 30 mm for prevention of the infringement of the skin and subcutaneous tissue.

The novel method of massage is more effective then the known methods of massage, including the method of massage that creates the friction between the skin's surface of the patient with reciprocating forward and backward linear or rotation motion of the influencing part of the massage device.

According an object of the present invention, the massage for improvement of body condition provides by repeating the linear, or spiral, or rotation movements, or some massage technique movements for palpation, for instance, stroking, rubbing or kneading, of the massage device with forward and backward reversible angular turning motion of the end of the influencing head of the massage device. The massage device with named above motion and variable pressure on the end of influencing head of the massage device applied along the patient's skin in the improvement of body condition zones.

According to the present invention, the massage for diagnosis, prevention or treatment consists of the linear, or spiral, or rotation movements of the massage device with forward and backward reversible angular turning motion of the end of the influencing head of the massage device and variable pressure applied along the skin's surface of the patient and checking the presence of pain in the diagnostic points, for instance, the reflected pains arising in the presence of the internal organs diseases. The massage device with named above motion of the end of the influencing head of the massage device and the pressure is stopped in the diagnostic point with the pain for and waiting of patient's response of pain, but not more then ten minutes. If the pain does not disappear in this time, continue the linear, or spiral, or rotation movements by the massage device with named motion of the end of the influencing head of the massage device and pressure in the area of the diagnostic point with pain until the pain disappears, but not more than ten minutes. If in this time the pain does not disappear, the patient needs more serious treatment, including possible surgical intervention.

The pain in the diagnostic points tells of pre-disease, when the patient does not feel himself as ill, or of disease of the patient organ in this area. The disappearance of pain tells the possibility of prevention disease or the result of treatment.

According to the present invention, the massage for diagnosis and treatment consists of linear, or spiral, or rotational movements of the massage device with forwards and backwards reversible angular turning motion and variable pressure of the end of the influencing head of the massage device applied along the patient's skin surfaces and checking the tissue swelling, or bone outgrowth, or the skin showing of red. The skin showing of red tells of the peripheral blood circulation level in the diagnostic area and the result of treatment by increasing of skin's reddening. The treatment consists of repeating the linear, or spiral, or rotational movements of the massage device with named motion of the end of the influencing head of the massage of the body.

The named above procedures have to repeat some session until the pain fully disappears or the treatment effect or improvement of body condition will be done.

Additional possibilities of the present invention are that the friction between the skin of patient and the end of influencing head of the massage device creates the electrostatic potential on the body surfaces or brings the useful substances such as medicine or the anti-inflammatory metal such cooper or silver to the skin's surface. Moreover, the electrostatic potential on the body surfaces has the anti-inflammatory and the pain relief effects.

The possibilities of the novel massage method exceed the possibilities of manual and known methods of massage in improving body condition and the treatment of numerous diseases. Moreover, the novel massage method can be used for stimulation of some exchange processes. Improvement of peripheral blood circulation, increasing the body serviceability, elimination of pain syndrome, improvement of cartilaginous tissue, elimination of tendons disorders, subcutaneous condensation and bones outgrowths, treatment some inflammation processes etc. The novel massage method can have a good use in the physical therapy, sport medicine, for a cosmetic purpose, and in everyday life even. The treatment with the proposed massage method can be combined with many known methods of treatment, including pharmacology, herbs and physiotherapy. This method intensified their activity in the process of such treatment in the majority of cases.

Many types of the massage devices can be designed for the method of diagnosis, prevention and treatment diseases, and improvement of body condition. Some types of the massage devices presented in this invention.

According to the present invention, the main principle of massage device designs comprising the forward and backward reversible angular turning motions mechanism such as the reversible electrical engine with the mechanical or electrical forward and backward angular turning system of revers. This mechanism is located in the housing of the massage device and contains a moving part that contains the influencing head with the end in the form of the friction surface. The friction surface is executed in the form of applying the maximum contact with patient's skin such as flat or partly spherical form.

According to the present invention, the forwards and backwards reversible angular turning motion mechanism is the electric engine with the mechanical system of revers. This mechanism is located in the housing of the massage device. The moving part of this mechanism is the shaft of the electric engine, and the shaft contains the changeable influencing head on the open end. The middle part or the second end of the shaft contains the mechanical system for revers. The system for revers consists of two legs attached to the shaft. One leg is for applying contact with the operating switch with normally closet lug terminals, and the second leg contains the attached spring for revers, and both the operating switch and the spring are attached to the housing. The housing contains the electric battery or source of current. The electric cord of the electric buttery or the source of current is attached to the electric engine via the main switch with normally open lug terminals and the operating switch with normally closet lug terminals.

According to the present invention, the forward and backward reversible angular turning motion mechanism is the reversible direct current electrical engine located in the housing of the massage device. The moving part is the shaft of the electric engine. The shaft contains the changeable influencing head on the open end. And the cord of the source of alternative current is attached via the capacitor and the switch to the electric engine.

The changing of the power parameters from the electric source to the reversible forward and backward angular turning motion mechanism can be produced by the transformer and capacitor.

According to the present invention, the friction surface of the influencing head of the massage device executed or covered with material, which creates the electrostatic potential on the body surfaces, such as ebonite or amber, or contains useful substances such as medicine or anti-inflammatory metal such as cooper or silver.

And the housing of the massage device can be executed in the form of a pistol.

### BRIEF DESCRIPTION OF THE DRAWINGS

For more detailed explanation and understanding persisting invention by description of the method and design of the massage device below presented drawings, which is an explanation to figures:

FIG. 1 presents the perspective view of the massage device with the direct current electrical engine and the mechanical system of revers, and the pistol form of housing with the section views of the main part's designs of the massage device.

FIG. 2 presents the perspective view of the moving parts of the massage device with the electric engine and the mechanical system of revers.

FIG. 3 presents the electrical diagram of the massage device with the electric engine and the mechanical system of revers.

FIG. 4 presents the electrical diagram of the massage device with the electrical engine and the alternative current supplying.

FIG. 5 presents the perspective view of the massage device with the direct current electrical engine and the alternative current supplying, and the housing of the pistol form with section views of main part's designs of the massage device.

Figures presented the views of types of the end of the influencing head of the massage device. FIG. 6a with the flat friction surface, FIG. 6b with the flat friction surface covered with special material, FIG. 6c with the friction surface partly spherical form.

### DETAILED DESCRIPTION OF THE DRAWINGS

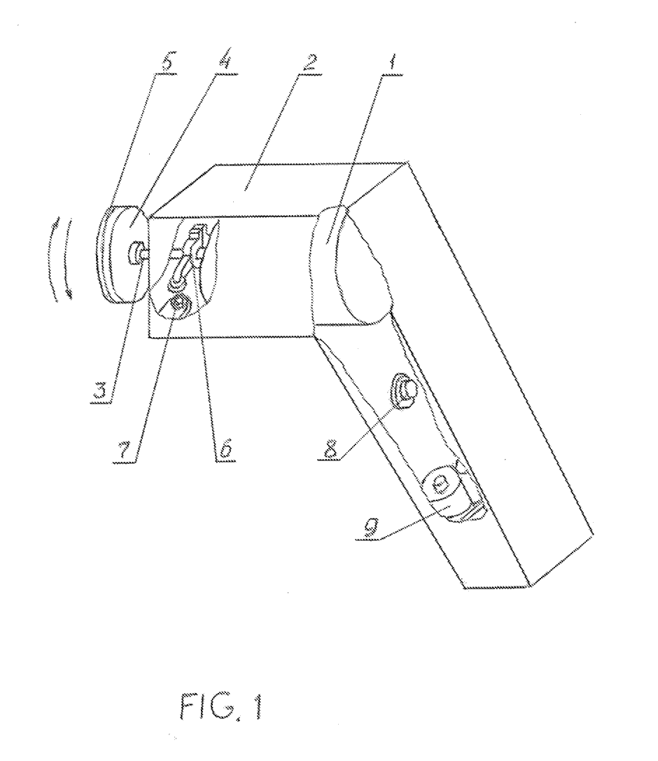

FIG. 1 presents the general view in perspective of the massage device operated by direct current. The massage device consisting of the electric engine 1 located in the pistol form housing 2. The shaft 3 of the electric engine 1 contains the changeable influencing head 4 on the open end and the system for revers 6 in the middle part. The influencing head 4 covered with material 5 such as ebonite, which creates the electrostatic potential on the skin's surface. The housing 2 contains the operating switch with normally closet lug terminals 7, the main switch with normally open lug terminals 8 and the electric battery 9.

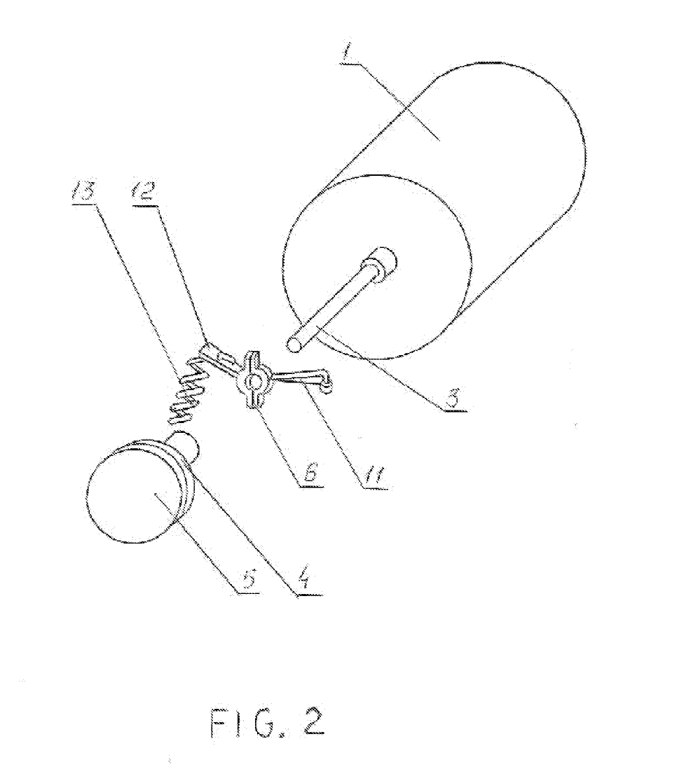

FIG. 2 presents the perspective view of the moving parts of the massage device consisting of the shaft 3 of the electric engine 1. The shaft 3 in the middle part contains the system for revers 6 that consists of two legs. One leg 11 is for applying contact with the operating switch with normally closet lug terminals 7 and the second leg 12 contains attached spring 13 for revers. The open end of the shaft 3 contains the changeable influencing head 4. The end of head 4 is covered with material 5, which can create the electrostatic potential on the body surface such as ebonite.

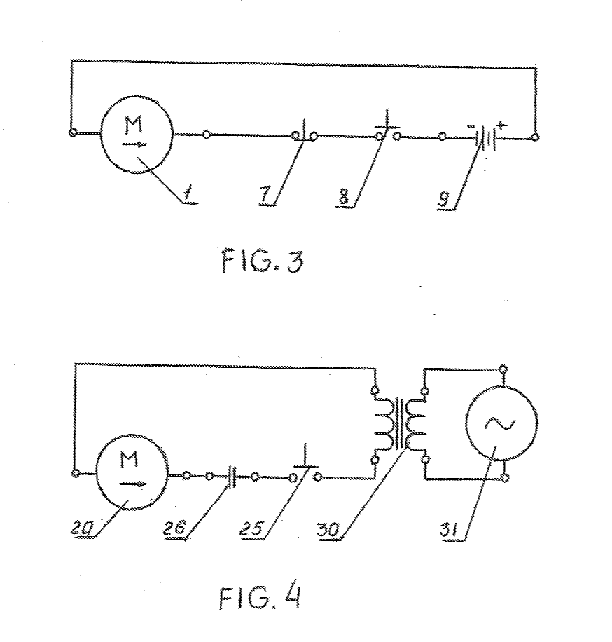

FIG. 3 presents the electrical diagram of the massage device operated by direct current. The diagram consists of the electric engine 1, the electric battery 9, the main switch with normally open lug terminals 8 and the operating switch with normally closet lug terminals 7. The massage device operated by direct current works in the next manner: when the main switch 8 is turned on, the electric engine 1 receives the electric current from the electric battery 9 and turns its shaft 3 together with influencing head 4 and both legs 11 and 12 of the system of revers 6. The contacting leg 11 attracts the operating switch with normally closet lug terminals 7 and turns it off. The electric engine 1 is discharged and its shaft 3 together with the influencing head 4 stops. In the same time, the opposite leg 12 stretches out the spring 13. When the electric engine 1 is discharged, the spring 13 returns the shaft 3 together with influencing head 4 and both legs 11 and 12 of revers system 6 in the starting position. The operating switch with normally closets lug terminals 7 turns on, and the engine1 receives the electric current from the electric battery 9 and turns its shaft 3. And the process is repeated. When the shaft 3 turns together with influencing head 4 forward and backward the end of the influencing head 4 under manual pressure applied to the patient skin's surface, this movement creates the friction with the patient's skin. Skin turns forward and backward with partly sliding under influence of this friction. This forwards and backwards reversible angular turning movement of the skin creates the pumping effect of blood circulation. As result, the blood circulation in the influenced part of the skin increases and the treatment and diagnosis effects are produced. Moreover, the friction of the skin by ebonite, amber, cooper, silver and medicine produces electrostatic potential on the skin and gives additional treatment effect such as pain relief and anti-inflammatory property.

These possibilities of the massage device give the opportunities of diagnosis, prevention and treatment diseases, and improvement of a body condition in the numerous diseases possible and can have use in the physical therapy, sport medicine, for a cosmetic purpose, and in everyday life even.

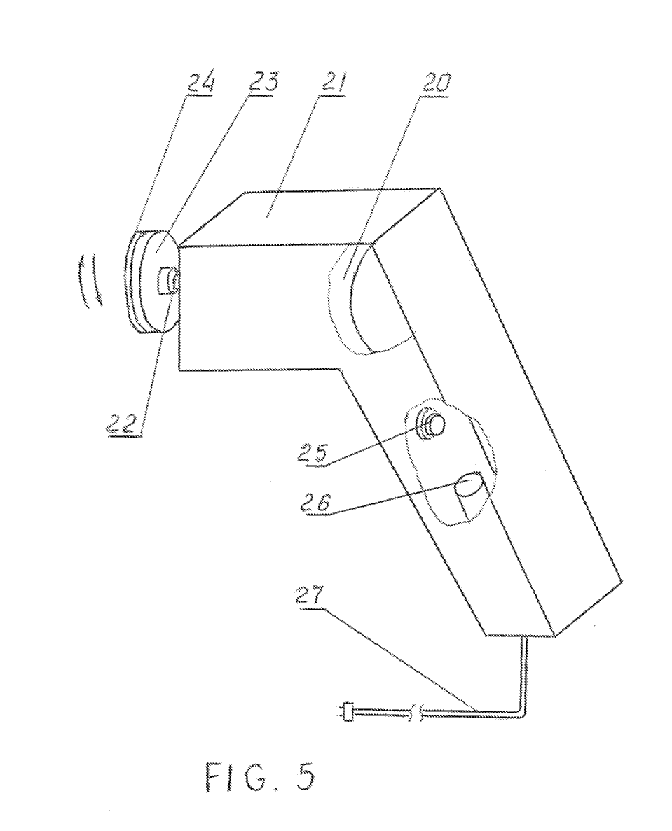

FIG. 4 presents the electrical diagram of the massage device operated by alternative current. The diagram consists of the sours of alternative current 31, the transformer 30, the main switch 25 with normally open lug terminals, the capacitor 26, and the reversible direct current electric engine 20.

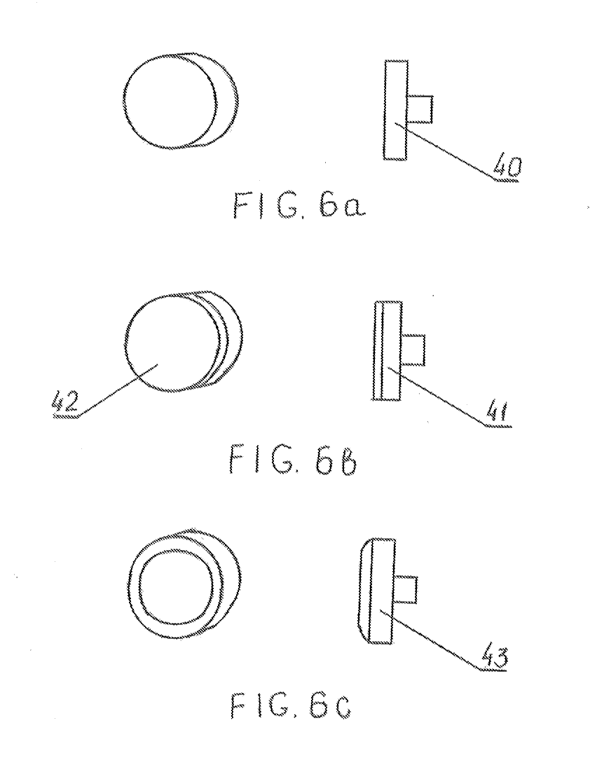

FIG. 5 presents the general view in perspective of the massage device operated by alternative current. The massage device consists of the electric engine 20 located in the pistol form housing 21. The shaft 22 of the electric engine 20 contains the changeable influencing head 23 on the open end. The influencing head 23 covered with material 24, which creates the electrostatic potential on the body surface such as ebonite. The housing 21 contains the switch 25, the capacitor 26, and electric cord 27 for contact with the source of alternative current via standard transformer 30. The transformer 30 is disposed separately.

The massage device operated by alternative current has the same possibilities as the massage device operated by direct current. The forwards and backwards reversible angular turning motion of the influencing head 23 of the electric engine 20 is produced by alternative current.

Figures present the general views of the influencing head of the massage device: FIG. 6a with the flat friction surface 40, FIG. 6b with the flat friction surface 41 covered with material 42, which creates the electrostatic potential on the body surfaces such as ebonite or contains useful substances such as medicine or anti-inflammatory metal such as cooper or silver, FIG. 6c with the partly spherical form friction surface 43.

It should be understood that the preferred embodiments and examples described herein are for illustrative purposes only and are not to be construed as limiting the scope of the present invention which is properly delineated only in the appended claims. It should also be understood that the drawings are not necessarily drawn to scale, but that they are merely conceptual in nature.

We claim:

1. The method of massage for improving the body condition, diagnosis, prevention and treatment of diseases consists of creating the friction between the skin's surface of the patient and the end of the influencing head of the massage device with forward and backward reversible angular turning motion of the said influencing head, and a stop, for instance, in the point of pain, or the movements of the massage device along the patient's skin surface, for instance, the linear and/or spiral and/or rotation movements in the treatment zones, with the constant or variable pressure applied to the skin's surface, and the maximum length of the moving of the patient's skin surface as a result of the said friction of the said influencing head is not more than 30 mm.

2. The method of massage for improvement of body condition, diagnosis, prevention and treatment of diseases according to claim 1 wherein the massage for improvement of body condition consists of repeating the said movements of the said massage device, for instance, the linear, and/or spiral, and/or rotational movements, and/or some massage technique movements for palpation, for instance, stroking and/or rubbing, with said forward and backward reversible angular turning motion of the said end of the influencing head with the said pressure applied along the patient's skin in the improvement of body condition zones.

3. The method of massage for improvement of body condition, diagnosis, prevention and treatment diseases according to claim 1 wherein the massage for diagnosis, prevention and/or treatment diseases consists of the said movements of the said massage device, for instance, the linear, and/or spiral, and/or rotational movements, with said forward and backward reversible angular turning motion of the said end of the influencing head with the said pressure applied along the skin's surface of patient and checking the presence of pain in the diagnostic points, for instance, the reflected pains arising in the presence of the internal organs diseases, and stopping the said massage device with said motion of the said end of the influencing head with the said pressure in the said diagnostic point with pain and waiting for the patient's response to pain for some time, for instance, not more than two minutes, if the pain does not disappear, continue the said movements of the said massage device with said motion of the said end of the influencing head with the said pressure applied in the area of the said diagnostic point with pain until the pain disappears, but not more than ten minutes.

4. The method of massage for improvement of body condition, diagnosis, prevention and treatment diseases according to claim 1 wherein the massage for diagnosis and/or treatment consists of the said movements of the said massage device, for instance, the linear, and/or spiral, and/or rotational movements, with said forward and backward reversible angular turning motion of the end of the influencing head of the massage device with the said pressure applied along the patient's skin surface, checking the tissue swelling or bone outgrowth and/or the skin showing of red, and repeating the said movements of the said massage device with said motion of the end of the influencing head of the massage device with the said pressure applied along the patient's skin in the treatment areas of the body until the treatment effect is done, for instance, decreasing the tissue swelling or increasing the skin reddening.

5. The massage device comprising a forwards and backwards reversible angular turning motion mechanism, for instance, the reversible electrical engine, the said motion mechanism contains the mechanical and/or electrical forward and backward angular turning system of revers, the said motion mechanism contains a moving part, the said moving part contains the influencing head with the end in the form of the friction surface, for instance, flat and/or partly spherical form, and the said motion mechanism is located in the housing of the massage device.

6. The massage device according to claim 5 wherein the said forward and backward reversible angular turning motion mechanism is the electric engine, the said moving part is the shaft of the electric engine, the said shaft contains the changeable influencing head and the said system of revers, and the said system of revers consists of two legs, one leg of the said legs of the system for revers is for applying contact with the operating switch with normally closets lug terminals, and the second leg contains attached spring for revers, and both the said operating switch and the said spring is attached to the said housing, the said housing contains the source of current, for instance, the electric battery, and the electric cord of the said source of current is attached to the said electrical engine via the main switch with normally open lug terminals and the said operating switch with normally closet lug terminals.

7. The massage device according to claim 5 wherein the said forward and backward reversible angular turning motion mechanism is the reversible direct current electrical engine, the said moving part is the shaft of the electric engine, the said shaft contains the said changeable influencing head on the open end, and the cord of the source of alternative current is attached via the main switch to the said electrical engine.

8. The massage device according to claim 5 wherein the friction surface of the said end of the influencing head of the massage device executed or covered with material what applied of the patient body creates the electrostatic potential on the skin's surface, for instance, amber or ebonite, and/or contains useful substances, for instance, medicine or the anti-inflammatory metal, for instance, cooper or silver.
